(19) United States
(12) Patent Application Publication
(10) Pub. No.: US 2009/0303361 A1
(43) Pub. Date: Dec. 10, 2009

(54) SOLID-STATE IMAGE PICKUP APPARATUS

(75) Inventors: Masashi Saito, Tokyo (JP); Atsuko Kume, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/481,114

(22) Filed: Jun. 9, 2009

(30) Foreign Application Priority Data
Jun. 10, 2008 (JP) 2008-151701

(51) Int. Cl. H04N 5/335

(52) U.S. Cl. 348/294; 348/E05.091

(57) ABSTRACT

A solid-state image pickup apparatus includes: a pixel portion in which at least one pixel with a photo-electric conversion element is arranged; an analog/digital converter comprising: a delay circuit in which delay elements are connected in multiple stages, the delay elements having a delay amount in accordance with a difference between an output voltage that is output from the pixel portion for every pixel and a predetermined reference voltage; and a decoder portion that, after detecting a number of circulations, in the delay circuit, of a pulse propagating in the delay circuit and a number of stages, of the delay elements connected in multiple stages, through which the pulse has propagated, outputs a digital signal based on the detected number of circulations and stages for each of the pixels; and a control circuit which controls the analog/digital converter so as to modify a number of bits of the digital signal that is output from the analog/digital converter, in accordance with on a preset shooting mode, in which the control circuit modifies a period where the pulse propagates in the delay circuit.

### BACKGROUND OF THE INVENTION

1. Field of the Invention

The present invention relates to a solid-state image pickup apparatus for use in digital cameras, digital video cameras, endoscopes, or the like.

Priority is claimed on Japanese Patent Application No. 2008-151701 filed on Jun. 10, 2008, the contents of which are incorporated herein by reference.

2. Description of Related Art

Recently, digital cameras, digital video cameras, and endoscopes have advanced in terms of being downsized and having lower power consumption. Accordingly, it is required for solid-state image pickup apparatuses to be downsized and to have lower power consumption.

To actualize the downsizing and lower power consumption, there is proposed a solid-state image pickup apparatus in, for example, Japanese Unexamined Patent Publication, First Publication No. 2006-287879, in which an AD (analog/digital) conversion circuit is made of digital circuits.

FIG. 12 is a block diagram showing a schematic configuration of a conventional solid-state image pickup apparatus. The solid-state image pickup apparatus has a photo-electric conversion element. The solid-state image pickup apparatus includes array blocks (sub-arrays) B1, B2, . . . , B20, each of which is made of: a pixel block 901 in which pixels for outputting a pixel signal in accordance with an incident light amount are arranged two-dimensionally in an array form; and an AD converter 902 for AD converting a pixel signal from the pixel block 901. The array blocks B1, B2, . . . , B20 are arranged two-dimensionally (in four rows of five columns, in the example shown), to thereby constitute a pixel portion.

FIG. 13 is a block diagram showing one example of circuit configuration of the AD converter 902 in FIG. 12. The AD converter 902 includes a delay circuit 911 in which delay elements are connected in multiple stages, the delay elements having a delay amount in accordance with an input voltage for an input pulse. The AD converter 902 further includes a decoder portion 910 for sampling and decoding, at predetermined intervals, the number of stages in which the pulse has been delayed by the delay circuit 911.

The decoder portion 910 includes a counter circuit 912 for counting the number of times that a pulse has circulated in the delay circuit 911. The decoder portion 910 further includes a latch & encoder circuit 913 for counting the number of stages of the delay elements through which a pulse propagating in the delay circuit 911 has passed. The decoder portion 910 further includes an adder 914 for adding an output value of the latch & encoder circuit 913 to an output value of the counter circuit 912. The decoder portion 910 generates a digital value in accordance with an input voltage related to an input signal. Here, as an input signal, a pixel signal that is output from the pixel block 901 is input to the delay circuit 911.

### SUMMARY

The present invention has an object to provide a solid-state image pickup apparatus capable of obtaining a favorable image without regard to shooting conditions.

(1) A solid-state image pickup apparatus according to one aspect of the present invention includes: a pixel portion in which at least one pixel with a photo-electric conversion element is arranged; an analog/digital converter comprising: a delay circuit in which delay elements are connected in multiple stages, the delay elements having a delay amount in accordance with a difference between an output voltage that is output from the pixel portion for every pixel and a predetermined reference voltage; and a decoder portion that, after detecting a number of circulations, in the delay circuit, of a pulse propagating in the delay circuit and a number of stages, of the delay elements connected in multiple stages, through which the pulse has propagated, outputs a digital signal based on the detected number of circulations and stages for each of the pixels; and a control circuit which controls the analog/digital converter so as to modify a number of bits of the digital signal that is output from the analog/digital converter, in accordance with a preset shooting mode, in which the control circuit modifies a period where the pulse propagates in the delay circuit.
(2) In a solid-state image pickup apparatus according to one aspect of the present invention, the decoder portion may include: a counter circuit which counts a number of circulations that the pulse has circulated in the delay circuit; and a latch & encoder circuit which detects a number of stages through which the pulse has propagated in the delay element connected in multiple stages.
(3) A solid-state image pickup apparatus according to one aspect of the present invention may further include a number-of-bits control portion which adjusts a number of bits of the digital signal that is output from the analog/digital converter, in which the control circuit modifies the number of bits adjusted by the number-of-bits control portion in accordance with a preset shooting mode.
(4) A solid-state image pickup apparatus according to one aspect of the present invention includes: a pixel portion in which at least one pixel with a photo-electric conversion element is arranged; an analog/digital converter comprising: a delay circuit in which delay elements are connected in multiple stages, the delay elements having a delay amount in accordance with a difference between an output voltage that is output from the pixel portion for every pixel and a predetermined reference voltage; and a decoder portion that, after detecting a number of circulations, in the delay circuit, of a pulse propagating in the delay circuit and a number of stages, of the delay elements connected in multiple stages, through which the pulse has propagated, outputs a digital signal based on the detected number of circulations and stages for each of the pixels; and a control circuit which controls the analog/digital converter so as to modify a number of bits of the digital signal that is output from the analog/digital converter, in accordance with on a preset shooting mode, in which the control circuit modifies a counting period of the counter circuit which counts a number of circulations that the pulse has circulated in the delay circuit.
(5) In a solid-state image pickup apparatus according to one aspect of the present invention, the decoder portion may include: a counter circuit which counts a number of circulations that the pulse has circulated in the delay circuit; and a latch & encoder circuit which detects a number of stages through which the pulse has propagated in the delay element connected in multiple stages.
(6) A solid-state image pickup apparatus according to one aspect of the present invention may further include a number-of-bits control portion which adjusts a number of bits of the digital signal that is output from the analog/digital converter, in which the control circuit modifies the number of bits adjusted by the number-of-bits control portion in accordance with a preset shooting mode.

### BRIEF DESCRIPTION OF THE DRAWINGS

FIG. 1 is a schematic diagram showing a configuration of a solid-state image pickup apparatus according to a first embodiment.

FIG. 2 is a configuration diagram showing a configuration of the AD converter of FIG. 1.

FIG. 3 is a timing chart for a case of normal mode in the solid-state image pickup apparatus of FIG. 1.

FIG. 4 is a timing chart for a case of high-resolution mode in the solid-state image pickup apparatus of FIG. 1.

FIG. 5 is a timing chart showing an operation of a solid-state image pickup apparatus according to a second embodiment.

FIG. 6 is a timing chart showing an operation of a solid-state image pickup apparatus according to a third embodiment.

FIG. 7 is a timing chart showing an operation of a solid-state image pickup apparatus according to a fourth embodiment.

FIG. 8 is a timing chart showing an operation of a solid-state image pickup apparatus according to a fifth embodiment.

FIG. 9 is a configuration diagram showing a configuration as one example of an AD converter according to a sixth embodiment.

FIG. 10 is a configuration diagram showing a configuration of a solid-state image pickup apparatus according to a seventh embodiment.

FIG. 11 is a configuration diagram showing a configuration of an AD converter of FIG. 10.

FIG. 12 is a block diagram showing a schematic configuration of a conventional solid-state image pickup apparatus.

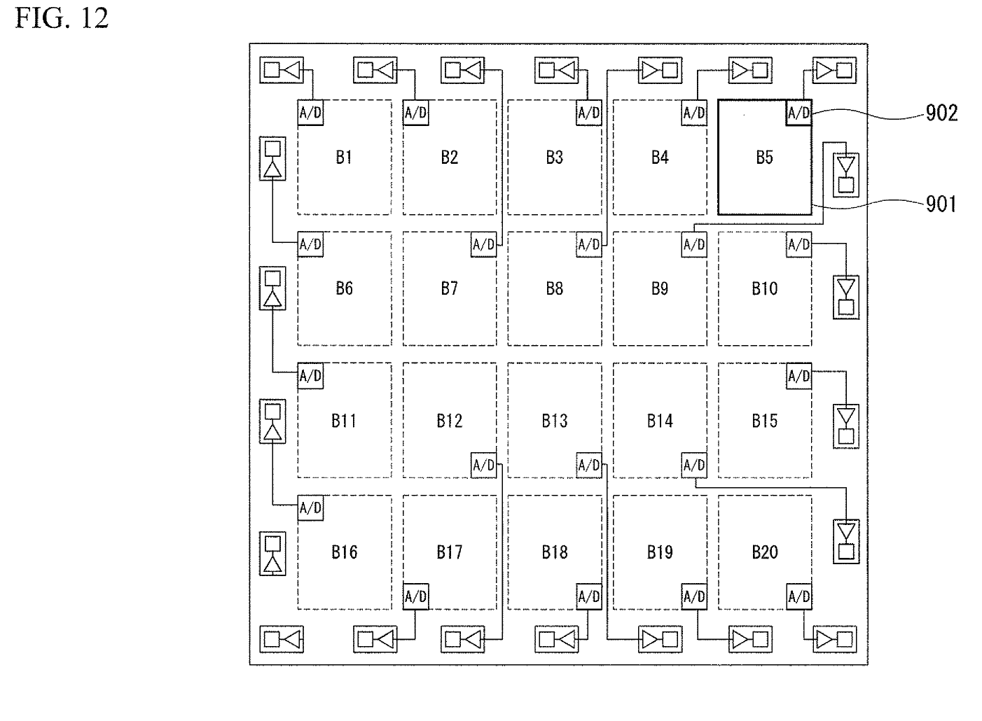

FIG. 13 is a block diagram showing one example of circuit configuration of the AD converter of FIG. 12.

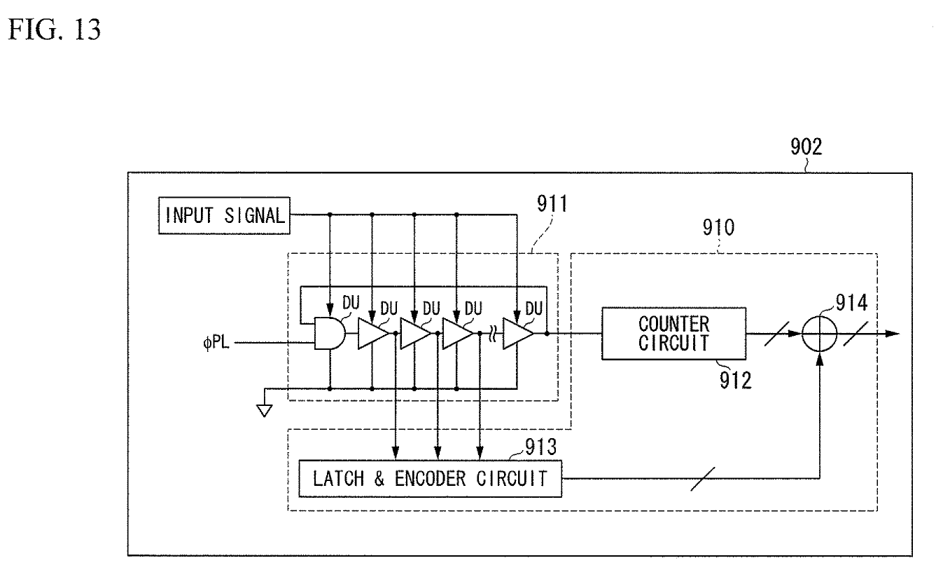

### DETAILED DESCRIPTION OF PREFERRED EMBODIMENTS

### First Embodiment

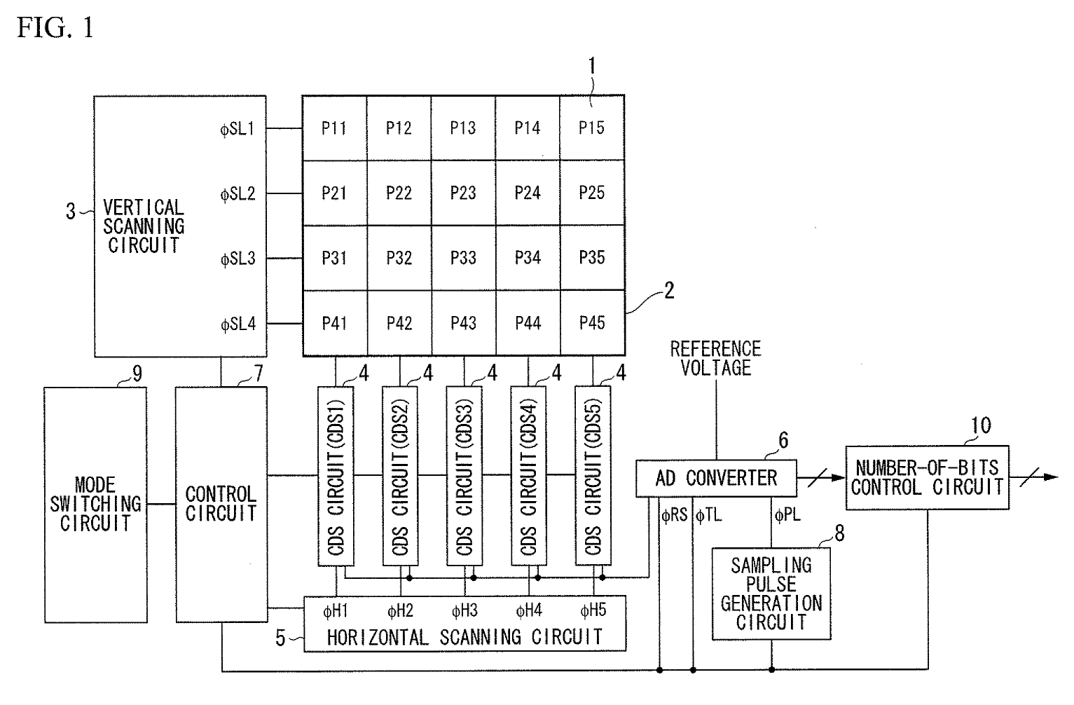

Hereunder is a description of embodiments of the present invention with reference to the drawings. FIG. 1 is a schematic block diagram showing a configuration of a solid-state image pickup apparatus according to a first embodiment. With reference to FIG. 1, the configuration of the solid-state image pickup apparatus according to the first embodiment will be described.

The solid-state image pickup apparatus according to the first embodiment includes: a pixel array 2; a vertical scanning circuit 3; CDS (Correlated Double Sampler) circuits 4; a horizontal scanning circuit 5; an AD (analog/digital) converter 6; a control circuit 7; a sampling pulse generation circuit 8; a mode switching circuit 9; and a number-of-bits control circuit 10.

In the pixel array 2, a plurality of pixels 1 are arranged two-dimensionally ((in four rows of five columns, in the example shown). The vertical scanning circuit 3 causes the pixel array 2 to control a vertical scanning. The CDS circuits 4 are arranged two-dimensionally, each corresponding to each column of pixels 1.

Every pixel 1 has at least a photo-electric conversion element, and outputs a pixel signal according to an incident light amount. Every CDS circuit 4 outputs a signal that has been output from the corresponding pixels 1, with its noise in resetting being suppressed. The horizontal scanning circuit 5 controls the signal readout by every CDS circuit 4.

The AD converter 6 AD-converts the signals that are sequentially output from the CDS circuits 4 and outputs them as pieces of image data. To the AD converter 6, the pixel signals that have been output from the CDS circuits 4 are input as input signals in order of the CDS circuits 4.

The sampling pulse generation circuit 8 generates a sampling pulse to be used in the AD converter 6 as an input pulse φPL, and outputs the generated input pulse φPL to the AD converter 6. As will be described later, during the period when the input pulse φPL is High, the AD converter 6 AD-converts the signals that have been output from the CDS circuits 4.

The number-of-bits control circuit 10 modifies the number of bits of a signal that have been output from the AD converter 6 and then outputs them. For example, if the signal that has been output from the AD converter 6 has 14 bits, the number-of-bits control circuit 10 modifies the number of bits of the signal by deleting its upper two bits into its lower 12 bits and then outputs them.

The mode switching circuit 9 switches shooting modes. For example, through the operation by the user who is operating the solid-state image pickup apparatus on the operation portion thereof, an optional shooting mode is selected from among previously-set shooting modes and switched. The mode switching circuit 9 outputs the shooting mode selected by the user to the control circuit 7 to thereby switch the shooting modes.

The solid-state image pickup apparatus may have previously-set shooting modes prestored in a shooting mode information storage portion included therein. In addition, the user selects an optional shooting mode from among the shooting modes stored in the shooting mode information storage portion.

The shooting mode information storage portion may prestore information for modifying a shooting condition as shooting condition information associated with the shooting modes. The shooting condition information is, for example, information for modifying the period where the input pulse φPL, which will be described later, is High.

Instead of allowing the user to select a shooting mode, the mode switching circuit 9 may select and switch to a shooting mode from among the shooting modes stored in the shooting mode information storage portion, based on an image detected by the pixels 1.

The control circuit 7 controls the vertical scanning circuit 3, the CDS circuits 4, the horizontal scanning circuit 5, the AD converter 6, the sampling pulse generation circuit 8, and the number-of-bits control circuit 10. For example, the control circuit 7 outputs a reset signal φRS and a transfer control signal φTL to the AD converter 6, to thereby control the AD converter 6.

Furthermore, the control circuit 7 controls the aforementioned circuits in accordance with the shooting mode that has been input from the mode switching circuit 9. Furthermore, the control circuit 7 reads, for example, the shooting condition information concerned with the shooting mode that has been input from the mode switching circuit 9, from the shooting mode information storage portion of the mode switching circuit 9. The control circuit 7 then controls the aforementioned circuits based on the shooting condition information that has been read.

The pixel array 2 has a plurality of pixels 1 arranged two-dimensionally in four rows of five columns. Hereinafter, the pixels 1 in the first row will be referred to as pixels P11, P12, P13, P14, and P15 in order of columns. Similarly, the pixels 1 in the second row will be referred to as pixels P21, P22, P23, P24, and P25. The pixels 1 in the third row will be referred to as pixels P31, P32, P33, P34, and P35. The pixels 1 in the fourth row will be referred to as pixels P41, P42, P43, P44, and P45.

Furthermore, hereinafter, the CDS circuit 4 that corresponds to the pixels P11, P21, P31, and P41, which are the pixels in the first column, will be referred to as a CDS1. Similarly, the CDS circuit 4 that corresponds to the pixels P12, P22, P32, and P42, which are the pixels in the second column, will be referred to as a CDS2. The CDS circuit 4 that corresponds to the pixels P13, P23, P33, and P43, which are the pixels in the third column, will be referred to as a CDS3. The CDS circuit 4 that corresponds to the pixels P14, P24, P34, and P44, which are the pixels in the fourth column, will be referred to as a CDS4. The CDS circuit 4 that corresponds to the pixels P15, P25, P35, and P45, which are the pixels in the fifth column, will be referred to as a CDS5.

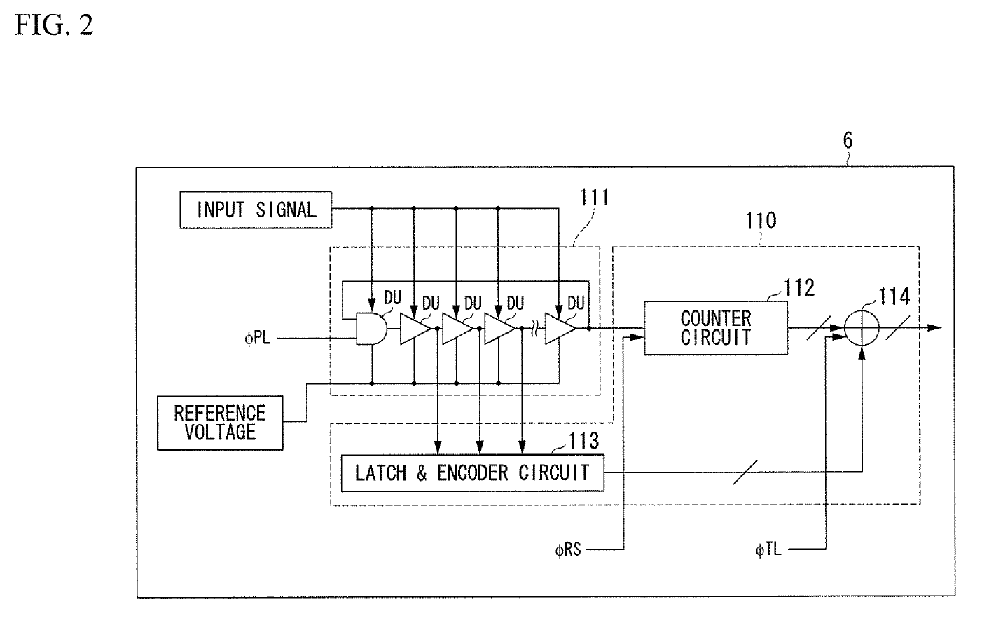

FIG. 2 is a configuration diagram showing a configuration of the AD converter 6 mounted in the solid-state image pickup apparatus according to the first embodiment shown in FIG. 1.

In the AD converter 6, delay elements DU are connected in multiple stages. The AD converter 6 includes: a delay circuit 111 through which travels a pulse with a delay amount in accordance with the difference between the voltage of an input signal and a reference voltage; and a decoder portion 110 for counting the number of circulations of and detecting the traveling position of a pulse in the delay circuit 111. Note that the phrase “a pulse travels” means the fact that a pulse propagates. Furthermore, the traveling position of a pulse in the delay circuit 111 means the number of stages of the delay elements DU in the delay circuit 111 through which the pulse has propagated, the delay elements DU being connected in multiple stages.

The delay circuit 111 has a configuration in which the delay elements DU are connected in multiple stages. Every delay element DU operates from the voltage of an input signal that has been input from the CDS circuit 4 and the reference voltage as source voltages. In the delay circuit 111, the delay element DU in the first stage is an AND circuit. The delay elements DU in the stages other than the first stage are delay circuits or buffer circuits. To one input terminal of the AND circuit as the delay element DU in the first stage, an input pulse φPL from the sampling pulse generation circuit 8 is input. To the other input terminal thereof, an output of the delay element DU in the final stage is input.

The delay circuit 111 generates a clock signal with an amplitude and a frequency in accordance with the voltage of an input signal that has been input and with the reference voltage. Here, a description is given in which an AND circuit and delay circuits are used as constituents of the delay circuit 111. However, a NAND circuit and inverter circuits may be used.

The decoder portion 110 includes: a counter circuit 112; a latch & encoder circuit 113; and an adder 114. To the counter circuit 112, the output of the delay element DU in the final stage in the delay circuit 111 is input. The counter circuit 112 counts the number of circulations of a pulse traveling in the delay circuit 111 as a count value.

To the latch & encoder circuit 113, outputs from the delay elements DU in the delay circuit 111 are input. The latch & encoder circuit 113 detects traveling positions that the pulses in the delay elements DU in the delay circuit 111 have reached, that is, the number of stages of the delay elements DU in the delay circuit 111 through which the pulse has propagated.

The adder 114 calculates a digital signal corresponding to the input signal by a predetermined calculation method based on the count value counted by the counter circuit 112 and on the number of stages of the delay elements DU detected by the latch & encoder circuit 113. The adder 114 outputs the calculated digital signal to the number-of-bits control circuit 10.

### <Case of Normal Mode>

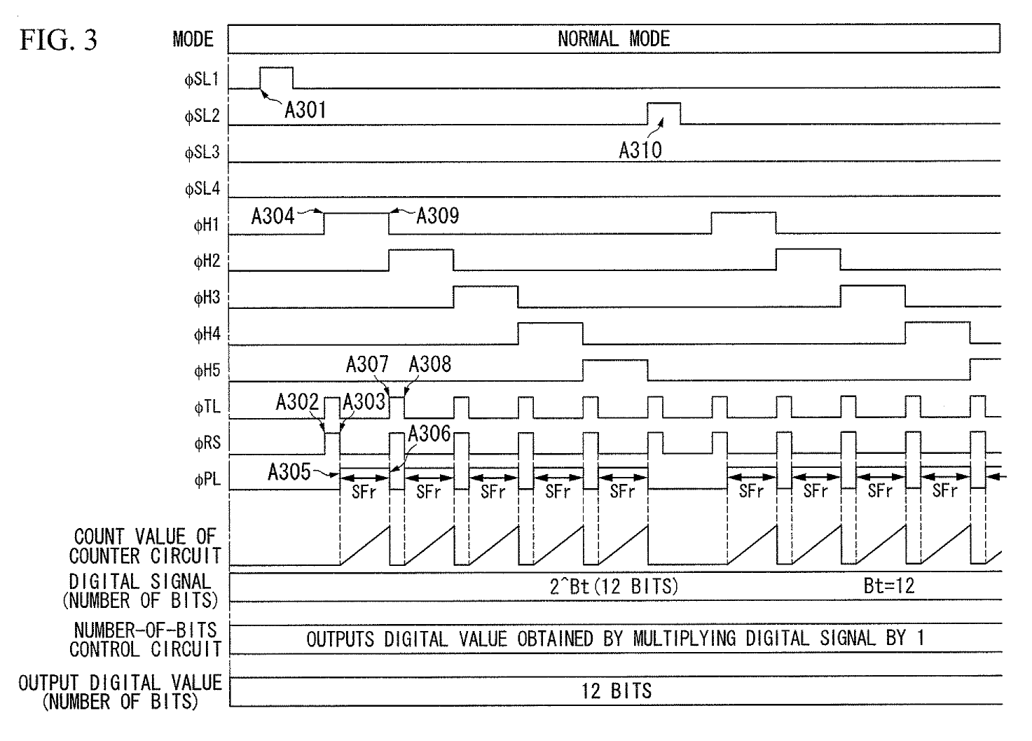

Next is a description of an operation in normal mode of the solid-state image pickup apparatus configured as shown in FIG. 1 with reference to the timing chart shown in FIG. 3. Note that in the mode switching circuit 9, normal mode is selected.

First, a pixel selection signal φSL1 that is output from the vertical scanning circuit 3 is turned to High (see reference numeral A301). Then, the pixels 1 (pixel P11, pixel P12, pixel P13, pixel P14, pixel P15) that are controlled by the pixel selection signal φSL1 are selected.

Next, signals of the selected pixels 1 pixel P11, pixel P12, pixel P13, pixel P14, and pixel P15) are output respectively to the corresponding CDS circuits 4 (CDS1, CDS2, CDS3, CDS4, and CDS5). At this time, the other pixel selection signals φSL2, φSL3, and φSL4 remain Low.

From the selected pixels 1 (pixel P11, pixel P12, pixel P13, pixel P14, and pixel P15), two signals are output: a signal in resetting that is output when the pixel 1 is reset and a light signal corresponding to the received light. The corresponding CDS circuits 4 (CDS1, CDS2, CDS3, CDS4, and CDS5) each calculate the difference in voltage between the two signals that have been input, to thereby generate a signal (a voltage) with a suppressed noise in resetting.

Then, with the control circuit 7 turning a reset signal φRS to High (see reference numeral A302), the counter circuit 112 of the AD converter 6 is reset to its default state, turning the reset signal φRS to Low (see reference numeral A303). This completes the reset of the counter circuit 112 to its default state.

A control signal φH1 that is output from the horizontal scanning circuit 5 is turned to High (see reference numeral A304), and a signal of the CODS circuit 4 (CDS1) for the first column that is controlled by the control signal φH1 is output to the AD converter 6. At this time, the other control signals φH2, φH3, φH4, and φH5 that are output from the horizontal scanning circuit 5 remain Low.

After that, the sampling pulse generation circuit 8 turns the input pulse φPL to High (see reference numeral A305). As a result, in the delay circuit 111 travels a pulse with a delay amount in accordance with the difference between the voltage of the input signal that is input from the CDS circuit 4 (CDS1) controlled by the control signal φH1, and the reference voltage. The counter circuit 112 counts the number of circulations of the pulse traveling in the delay circuit 111.

After a lapse of a predetermined period of time (SFr seconds, in the example shown), the sampling pulse generation circuit 8 turns the input pulse φPL to Low (see reference numeral A306). This stops the traveling of the pulse in the delay circuit 111.

After that, the adder 114 processes the count value counted by the counter circuit 112 and the data obtained by the latch & encoder circuit 113 to calculate a digital signal in accordance with the pixel 1 (pixel P11).

After that, the control circuit 7 turns the transfer control signal φTL to High (see reference numeral A307). With this, the adder 114 outputs the calculated digital signal to the number-of-bits control circuit 10. Next, the control circuit 7 turns the transfer control signal φTL to Low (see reference numeral A308). With this, the adder 114 completes the output of the calculated digital signal.

Then, the number-of-bits control circuit 10 outputs data obtained by multiplying the digital signal that has been input from the AD converter 6 by 1, as a digital value in accordance with the pixel 1 (pixel P11). Note that the number of bits of the digital value that is output here is Bt (Bt=12, in the example shown). Then, the control circuit 7 turns the control signal φH1 to Low (see reference numeral A309). This completes the signal readout from the CDS circuit 4 (CDS1).

After that, the control circuit 7 sequentially turns the control signals φH2, φH3, φH4, φH5 to High, and sequentially reads the signals of the CDS circuits 4 to sequentially execute the AD conversion. As a result, the signals of the pixels 1 (pixel P11, pixel P12, pixel P13, pixel P14, and pixel P15) in the first row selected by the pixel selection signal φSL1 are output.

Subsequently, the control circuit 7 turns the pixel selection signal φSL2 to High (see reference numeral A310), and the solid-state image pickup apparatus repeats the above operation for the case where the pixel selection signal φSL1 is turned to High. As a result, the readout of the pixels (pixel P21, pixel P22, pixel P23, pixel P24, and pixel P25) in the second row is performed similarly in the case of the pixels in the first row. Thus, the solid-state image pickup apparatus sequentially turns the pixel selection signals to High to perform the readout of all the pixels.

### <Case of High-Resolution Mode>

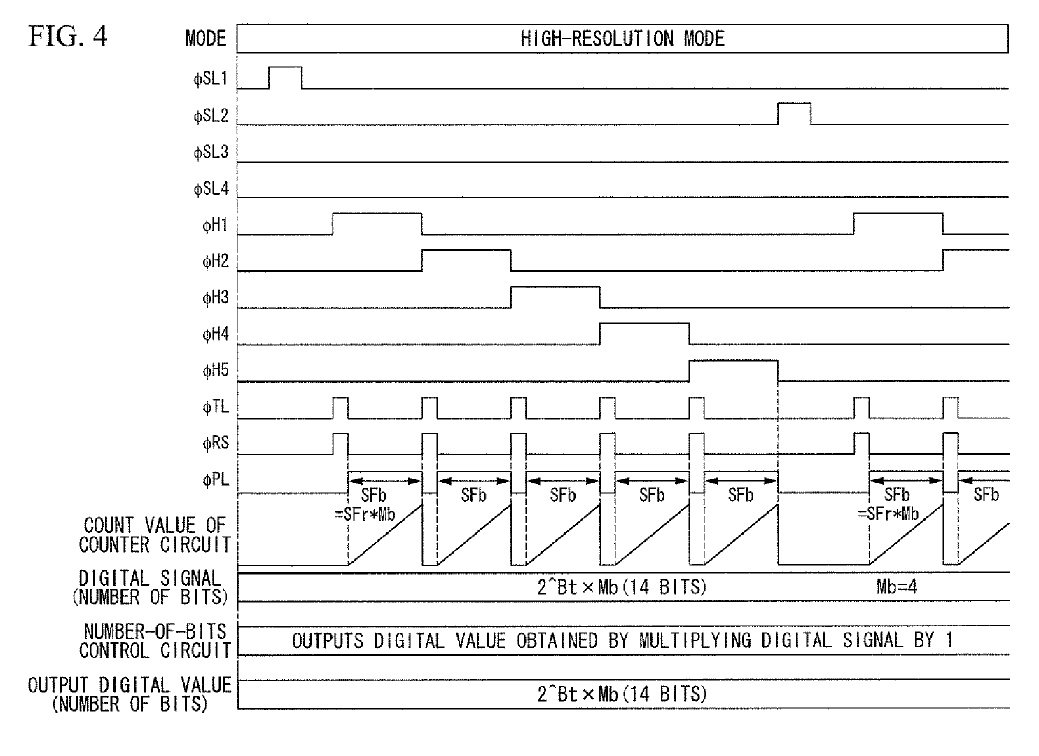

Next is a description of an operation in high-resolution mode with reference to the timing chart shown in FIG. 4, the high-resolution mode having an improved accuracy of signal processing and hence capable of offering a high-resolution image.

In the timing chart shown in FIG. 4, a high-resolution mode is selected in the mode switching circuit 9. This results in a difference from the timing chart shown in FIG. 3 in that the period where the input pulse φPL that is output by the sampling pulse generation circuit 8 is High (SFb, in the example shown) is Mb times (Mb=4, in the example shown) as long as that where the input pulse φPL in normal mode described with reference to FIG. 3 is High (SFr, in the example shown). In other points, the operation is the same as that shown in FIG. 3, and hence is not repetitiously explained.

With the period where the input pulse φPL that is input to the AD converter 6 is High being made Mb times as long, the count value (2̂ the number of bits) of the digital signal that is output from the AD converter 6 is Mb times as great. This results in increase in the number of obtained bits (14 bits, in the example shown). Hereinafter, the sign “̂” signifies exponentiation.

After that, the number-of-bits control circuit 10 outputs a value obtained by multiplying the digital signal that is output from the AD converter 6 by 1 as a digital value. This increases the number of bits of a digital value that is output, enabling improvement in accuracy of signal processing. Therefore, it is possible to obtain a high-resolution image from the solid-state image pickup apparatus.

### Second Embodiment

In a second embodiment, the case of low-noise mode will be described.

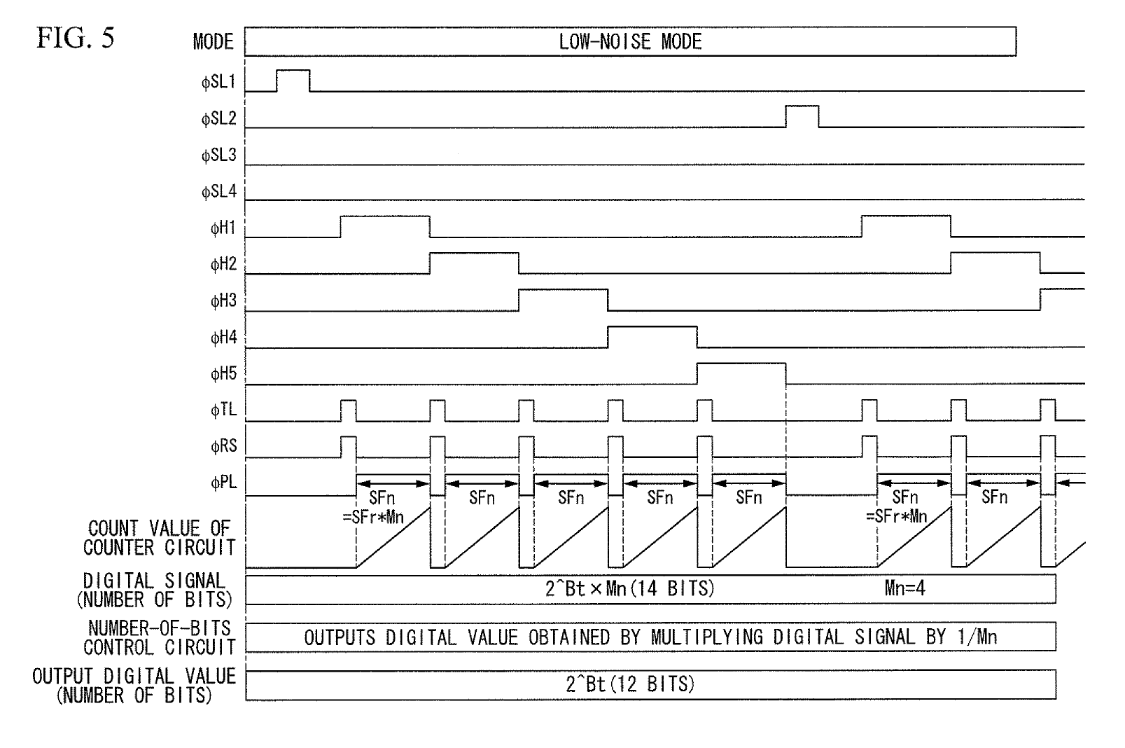

FIG. 5 is a timing chart showing an operation of a solid-state image pickup apparatus according to the second embodiment. Here, an operation is shown for the case where a low-noise image with a reduced random noise is obtained.

In the timing chart shown in FIG. 5, a low-noise mode is selected in the mode switching circuit 9 in contrast to the case of the normal operation (FIG. 3) of the solid-state image pickup apparatus described in the first embodiment. This results in a difference from the normal operation (FIG. 3) of the solid-state image pickup apparatus described in the first embodiment in that the period where the input pulse φPL is High (SFn, in the example shown) is Mn times (Mn=4, in the example shown) as long as that where the input pulse φPL in normal mode is High (SFr, in the example shown).

Furthermore, a difference also lies in that the control method of the number-of-bits control circuit 10 is configured to output a digital value obtained by multiplying the digital signal that is output from the AD converter 6 by 1/Mn.

In other points, the operation is the same as that shown in FIG. 3, and hence is not repetitiously explained.

With the period where the input pulse φPL that is input to the AD converter 6 is High being made Mn times as long, it is possible to obtain a digital signal the same as that in which a signal of the pixel is added Mn times. Onto each of the digital signals added Mn times, a random noise is superimposed.

After that, the number-of-bits control circuit 10 multiplies the digital signal that is output from the AD converter 6 by 1/Mn, to thereby level the digital signal. This makes it possible to reduce the amount of noise of the digital value that is output. As for the obtained digital value, it is possible to obtain a signal with Bt bits (12 bits, in the example shown) in normal mode.

With the above operation, it is possible to obtain a favorable image with a reduced amount of noise from the solid-state image pickup apparatus according to the second embodiment.

### Third embodiment

In a third embodiment, a long exposure mode will be described.

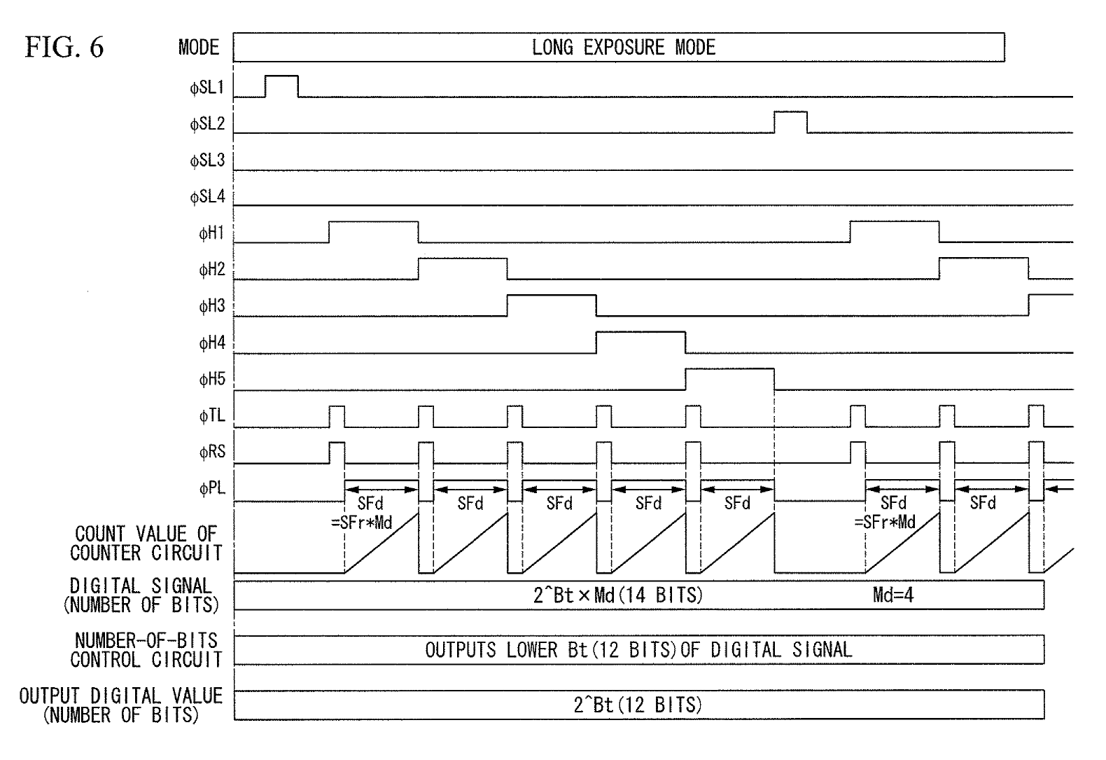

FIG. 6 is a timing chart showing an operation of a solid-state image pickup apparatus according to the third embodiment. It shows an operation of a long exposure mode in which exposure is performed when, at the time it is dark and at other times, a signal that is output from a pixel is small and at other times.

In the timing chart shown in FIG. 6, a long exposure mode is selected in the mode switching circuit 9 in contrast to the case of the normal operation (FIG. 3) of the solid-state image pickup apparatus described in the first embodiment. This brings about a difference in that the period where the input pulse φPL is High (SFd, in the example shown) is Md times (Md=4, in the example shown) as long as that where the input pulse φPL in normal mode is High (SFr, in the example shown).

Furthermore, a difference also lies in that the control method in the number-of-bits control circuit 10 is configured to output lower Bt bits (12 bits, in the example shown) of the digital signal that is output from the AD converter 6.

In other points, the operation is the same as that shown in FIG. 3, and hence is not repetitiously explained.

In this manner, the period where the input pulse φPL that is input to the AD converter 6 is High (SFd, in the example shown) is made Md times as long as that where the input pulse φPL in normal mode is High (SFr, in the example shown). As a result, the count value (2̂ the number of bits) of the digital signal that is output from the AD converter 6 is increased Md times (14 bits, in the example shown). After that, the number-of-bits control circuit 10 outputs only its lower Bt bits (12 bits, in the example shown).

As a result, the obtained digital value has a similar effect as that when the pixel signal is made Md times as great as the signal in the normal time. Even if a signal that is output from a pixel is small at the time it is dark and at other times, the solid-state image pickup apparatus is capable of optimizing the dynamic range. Therefore, it is possible to obtain a favorable image.

### Fourth Embodiment

In a fourth embodiment the case of high-speed mode will be described.

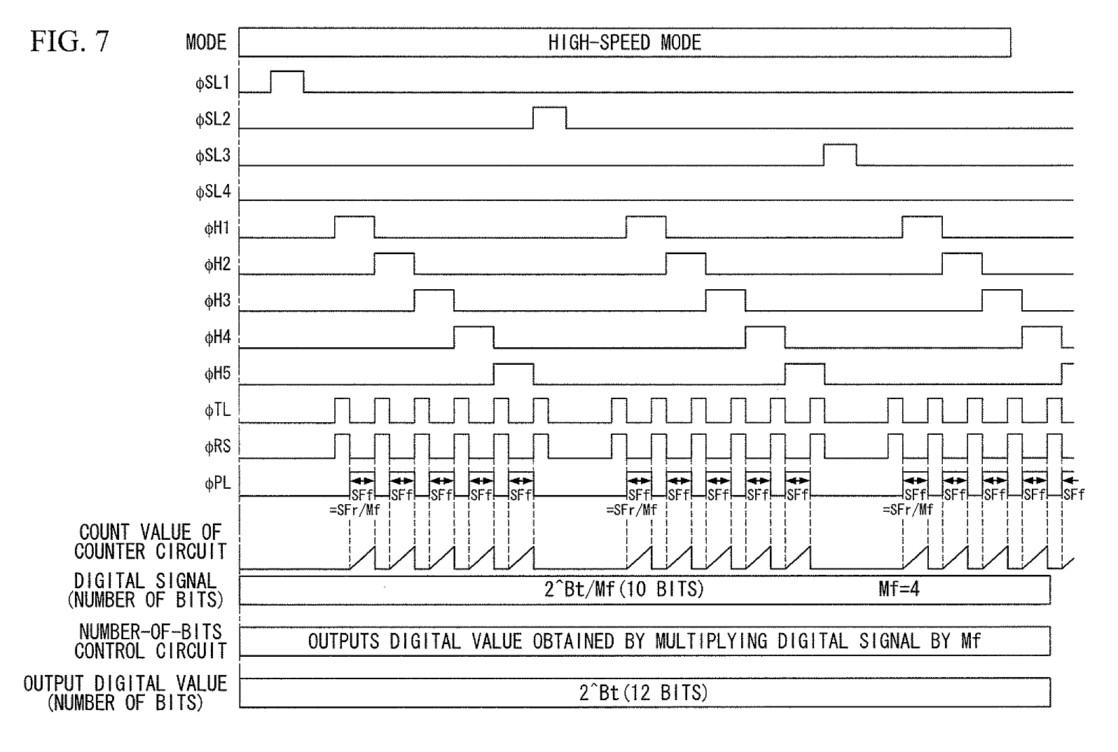

FIG. 7 is a timing chart showing an operation of a solid-state image pickup apparatus according to the fourth embodiment. In the timing chart shown in FIG. 7, a high-speed mode is selected in the mode switching circuit 9 in contrast to the case of the normal operation (FIG. 3) of the solid-state image pickup apparatus described in the first embodiment.

This results in a difference in that the period where the input pulse φPL is High is controlled so as to be SFr/Mf times as long.

Furthermore, a difference also lies in that the control method of the number-of-bits control circuit 10 is configured to output the digital signal that is output from the AD converter 6 after multiplying it by Mf (Mf=4, in the example shown).

In other points, the readout operation is the same as the normal readout operation shown in FIG. 3, and hence is not repetitiously explained.

In this manner, the period where the input pulse φPL of the AD converter 6 is High is increased by 1/Mf times as that in the normal time (SFr), to thereby make it possible to speedily obtain an image. However, the count value (2̂ the number of bits) of the digital signal that is output from the AD converter 6 is made 1/Mf times as great as that in normal mode. To address this, the number-of-bits control circuit 10 is configured to output, as a digital value, the value of the digital signal that is output from the AD converter 6 multiplied by ME. With the digital value thus obtained, it is possible to obtain a signal with Bt bits (12 bits, in the example shown) in normal mode.

As described above, by the selected mode (high-speed mode, in the example shown), the period where the input pulse φPL of the AD converter 6 is High is controlled, to thereby control the number of bits of an output signal. As a result, the solid-state image pickup apparatus is capable of obtaining an output digital value with the same number of bits as that in the normal time. Therefore, it is possible to speedily obtain an image.

### Fifth Embodiment

In a fifth embodiment, another operation of a solid-state image pickup apparatus will be described.

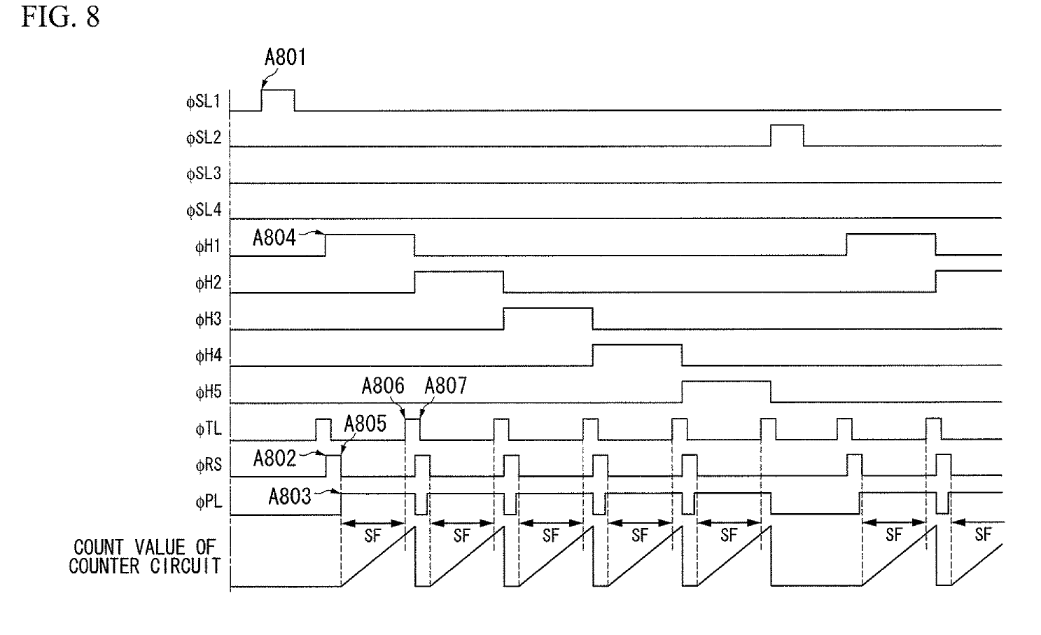

FIG. 8 is a timing chart showing an operation of the solid-state image pickup apparatus according to the fifth embodiment. In the timing chart shown in FIG. 7, a difference from the solid-state image pickup apparatus according to the first embodiment that has been described with reference to FIG. 3 lies in that the counting period (SF, in the example shown) of the counter circuit 112 in the AD converter 6 is controlled so as to be from the time when the reset signal φRS is turned from High to Low to the time when the transfer control signal φTL is turned to High.

Next, the operation of the solid-state image pickup apparatus according to the fifth embodiment will be described with reference to FIG. 8. First, a pixel selection signal φSL1 that is output from the vertical scanning circuit 3 is turned to High (see reference numeral A801). Then, the pixels 1 (pixel P11, pixel P12, pixel P13, pixel P14, and pixel P15) that are controlled by the pixel selection signal φSL1 are selected. The signals of the selected pixels 1 (pixel P11, pixel P12, pixel P13, pixel P14, and pixel P15) are output respectively to the corresponding CDS circuits 4 (CDS1, CDS2, CDS3, CDS4, and CDS5).

At this time, the other pixel selection signals φSL2, φSL3, and φSL4 remain Low.

From the selected pixels 1 (pixel P11, pixel P12, pixel P13, pixel P14, and pixel P15), voltages of two signals are output: a signal in resetting that is output when the pixel 1 is reset, and a light signal corresponding to the received light. The CDS circuits 4 (CDS1, CDS2, CDS3, CDS4, and CDS5) each calculate the difference in voltage between the two signals, to thereby generate a signal (a voltage) with a suppressed noise in resetting.

Then, with the control circuit 7 turning a reset signal φRS to High (see reference numeral A802), the counter circuit 112 of the AD converter 6 is reset to its default state. The sampling pulse generation circuit 8 then turns the input pulse φPL to High (see reference numeral A803).

With the input pulse φPL being turned to High, in the delay circuit 111 travels a pulse with a delay amount in accordance with the difference between the voltage of the input signal that is input from the CDS circuit 4 (CDS1) controlled by the control signal φH1, and the reference voltage. As a result, the AD converter is ready to AD-convert the signals of the pixels 1 (pixel P11, pixel P12, pixel P13, pixel P14, and pixel P15).

A control signal φH1 that is output from the horizontal scanning circuit 5 is turned to High (see reference numeral A804), and a signal of the CDS circuit 4 (CDS1) for the first column that is controlled by the control signal φH1 is output to the AD converter 6. At this time, the other control signals φH2, φH3, φH4, and φH5 that are output from the horizontal scanning circuit 5 remain Low.

After that, with the control circuit 7 turning the reset signal φRS to Low (see reference numeral A805), the counter circuit 112 starts to count the number of circulations of the pulse traveling in the delay circuit 111.

After a lapse of a predetermined period of time (SF, in the example shown), the control circuit 7 turns the transfer control signal φTL to High (see reference numeral A806). As a result, the value resulting from the processing, in the adder 114, of the count value counted by the counter circuit 112 and the data obtained by the latch & encoder circuit 113 is output as a digital signal in accordance with the pixel 1 (pixel P11) from the adder 114 to the number-of-bits control circuit 10.

After that, the control circuit 7 turns the transfer control signal φTL to Low (reference numeral A807). This completes the output of the digital signal.

The remainder of the operation and the drive method of the circuits of the solid-state image pickup apparatus are similar to those of the first embodiment described with reference to FIG. 3, and are not repetitiously explained. As has been described using FIG. 8, the control circuit 7 controls the transfer control signal φTL based on the mode that is set by the mode switching circuit 9. This makes it possible for the solid-state image pickup apparatus of the fifth embodiment to operate similarly to that of the first embodiment.

It is possible to apply the various modes described with reference to FIG. 4 to FIG. 8 to the solid-state image pickup apparatus according to the fifth embodiment, as is the case with the solid-state image pickup apparatus according to the first embodiment.

### Sixth Embodiment

In a sixth embodiment, a first modification of the AD converter will be described.

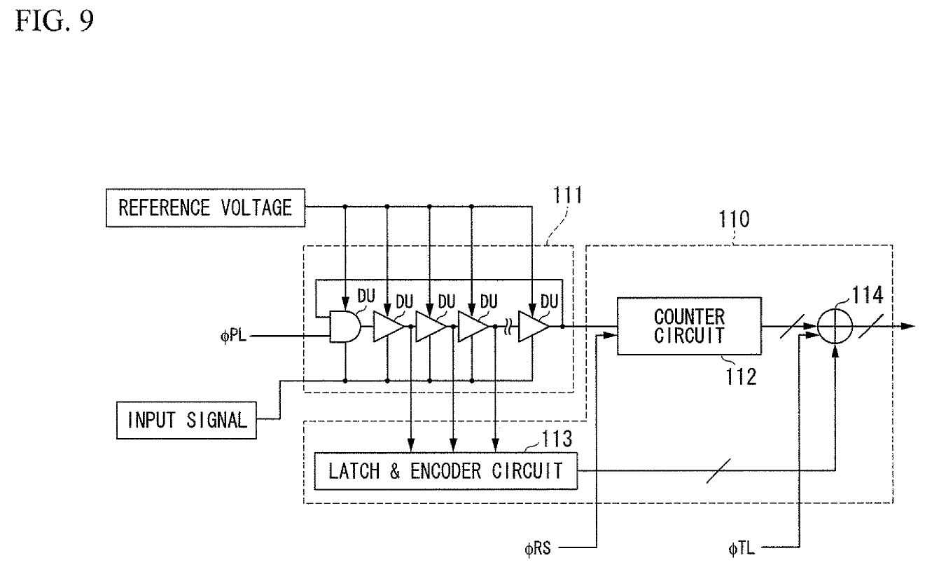

FIG. 9 shows a configuration of one example of an AD converter 6 according to the sixth embodiment. In FIG. 9, the AD converter 6 is different from that described with reference to FIG. 2 in that the input terminals of the input signal and the reference voltage are interchanged.

For example, in the AD converter 6 described with reference to FIG. 2, the reference voltage is applied to first terminals of the delay elements DU connected in multiple stages. Furthermore, the voltage of the input signal that has been input from the CDS circuit 4 is applied to second terminals of the delay elements DU. Note that the reference voltage in this case is, for example, a ground voltage.

However, in the AD converter 6 of FIG. 9, the reference voltage is applied to second terminals of the delay elements DU connected in multiple stages. Furthermore, the voltage of the input signal that has been input from the CDS circuit 4 is applied to first terminals thereof. Note that the reference voltage in this case is, for example, a voltage that is previously set higher than the voltage of the input signal.

Thus, in the AD converter 6, it is possible to input the input signal that has been input from the CDS circuit 4 and the reference signal in an interchanged manner to the second terminals and the first terminals of the delay elements DU connected in multiple stages.

Thus, the input signal that has been input from the CDS circuit 4 and the reference voltage are input in an interchanged manner to the second terminals and the first terminals of the delay elements DU connected in multiple stages. As a result, it is possible to obtain a favorable image in accordance with the value of the voltage of the input signal that has been input from the CDS circuit 4.

The remainder of the configurations of the AD converter 6 and the solid-state image pickup apparatus is the same as those of the first to fifth embodiments, and is not repetitiously explained. Even if the AD converter 6 is configured in this manner, the solid-state image pickup apparatus using the AD converter 6 is capable of obtaining an effect similar to that of the solid-state image pickup apparatuses according to the first to fifth embodiments.

### Seventh Embodiment

In a seventh embodiment, a second modification of the AD converter will be described.

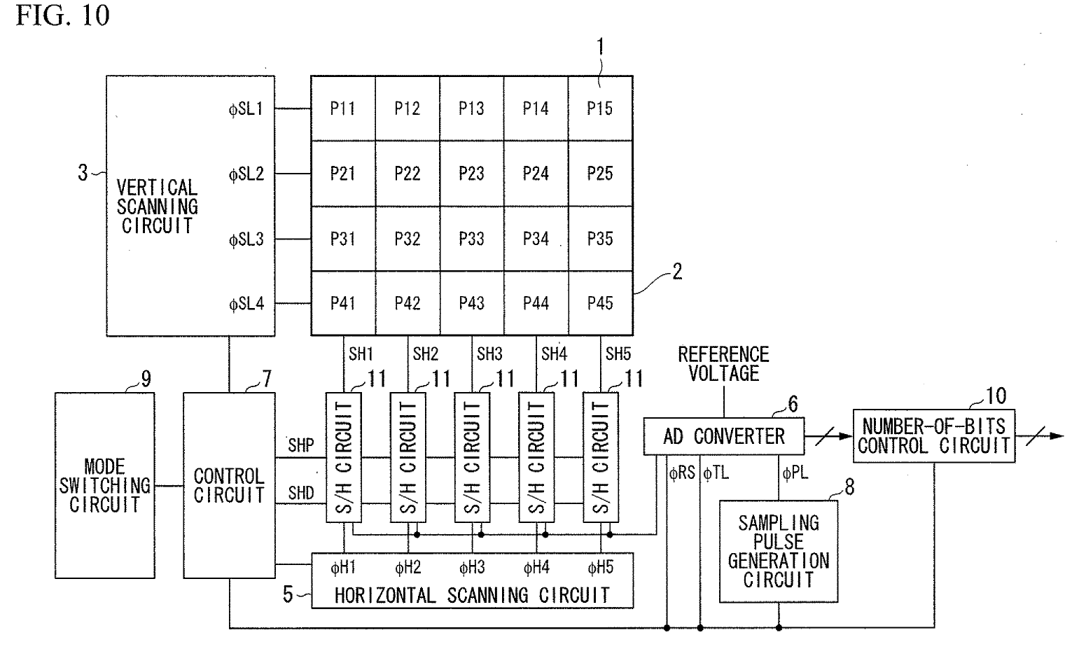

FIG. 10 shows an example of a solid-state image pickup apparatus according to the seventh embodiment. In the present embodiment, a difference lies in that S/H circuits (sample-hold circuits) 11 are provided instead of the CDS circuits 4 of the solid-state image pickup apparatus described with reference to FIG. 1. Each of the S/H circuit 11 holds and outputs two signals: a signal in resetting a pixel 1 and a signal corresponding to received light.

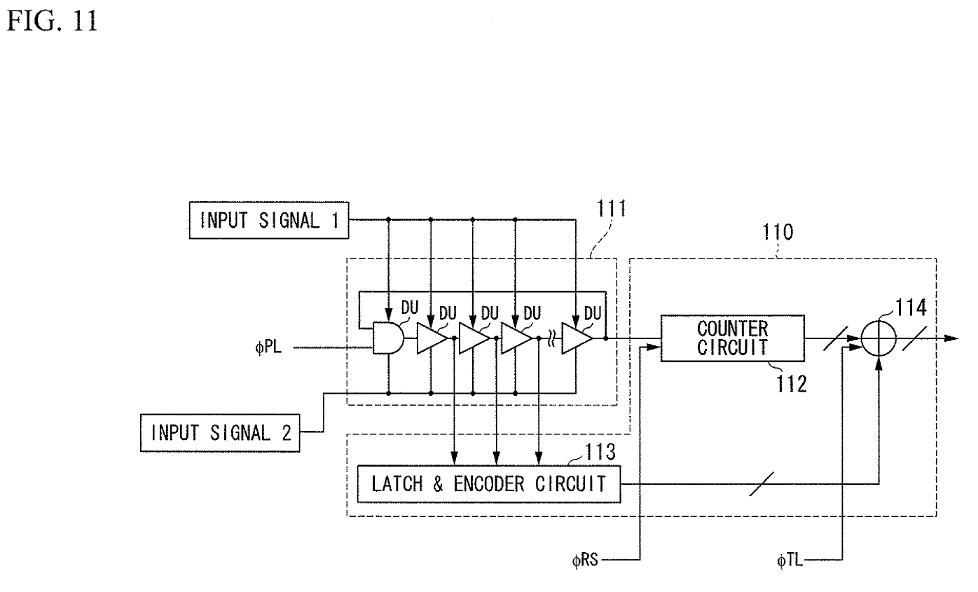

Furthermore, as shown in FIG. 11, another difference lies in that an input signal 2 is input to the AD converter 6 of FIG. 10, instead of the reference voltage in the delay circuit 111 according to the first to fifth embodiments. Note that, in FIG. 11, the input signal according to the first to sixth embodiments is denoted as input signal 1.

The input signal 1 is a signal corresponding to received light that is output from the S/H circuit 11. The input signal 2 is a signal in resetting a pixel 1 that is output from the S/H circuit 11. This correspondence may be reversed.

With the AD converter 6 configured in this manner, a delay circuit 111 of the AD converter 6 is capable of causing a pulse with a delay amount in accordance with the difference in voltage between the input signal 1 and the input signal 2 that are output from the S/H circuit 11 to travel.

Next is a description of an operation of the solid-state image pickup apparatus according to the seventh embodiment. First, a signal in setting a pixel that is output when the pixel 1 is reset (signal 1) is held in the S/H circuit 11. Then, a signal of a pixel corresponding to light received by the pixel 1 (signal 2) is held in the S/H circuit 11. Then, the signal 1 and the signal 2 held in the S/H circuit 11 are input to the AD converter 6, respectively as an input signal 1 and an input signal 2, respectively.

As a result, in the delay circuit 111 travels a pulse with a delay amount corresponding to the difference between two signals: the signal in resetting that is output when the pixel 1 is reset and the light signal corresponding to the received light. The remainder of the configurations of the AD converter and the solid-state image pickup apparatus is the same as those of the first to fifth embodiments, and is not repetitiously explained.

Even if the S/H circuits 11 are used instead of the CDS circuits 4 as is the case with the solid-state image pickup apparatus according to the seventh embodiment, it is possible to do shooting similarly to the case of the solid-state image pickup apparatus according to the first embodiment. Furthermore, the solid-state image pickup apparatus according to the seventh embodiment is capable of executing the shooting modes similar to those in the first to fifth embodiments. Therefore, the solid-state image pickup apparatus according to the seventh embodiment is capable of obtaining a similar effect to that of the solid-state image pickup apparatus according to the first to fifth embodiments.

In the above-described seventh embodiment, it is configured such that both of the signal 1 and the signal 2 are held in the S/H circuit 11 and are then input to the delay circuit 111. However, the configuration is not limited to this. For example, only one of the signal 1 and the signal 2 may be held in the S/H circuit 11 and then be output to the delay circuit 111; and the other thereof may be output directly to the delay circuit 111 without being held in the S/H circuit 11.

In the pixel array 2 of the above-described embodiments, a plurality of pixels 1 are arranged. However, any circuit configuration may be used so long as at least one pixel 1 that has a photo-electric conversion element and outputs a pixel signal in accordance with an incident light amount is arranged.

Furthermore, in the above embodiments, an AND circuit or a delay circuit is used for each of the delay elements DU of the delay circuit 111. However, apart from the circuit configuration in the above embodiments, any circuit configuration may be used so long as the circuit configuration allows a pulse with a delay amount in accordance with the difference between the voltage of the input signal and the reference voltage to travel.

In the above description, the control circuit 7 is different in configuration from the sampling pulse generation circuit 8. However, the present invention is not limited to this. For example, the control circuit 7 may have a configuration in which the control circuit 7 is integrated with the sampling pulse generation circuit 8. Alternatively, the control circuit 7 may have a configuration in which the horizontal scanning circuit 5 is integrated with the mode switching circuit 9.

According to the embodiments of the present invention, the drive method of the AD converter is optimally changed in accordance with the shooting mode corresponding to the shooting condition. That is, the number of bits for the AD converter is controlled. As a result, it is possible to provide a solid-state image pickup apparatus capable of obtaining a digital value of an image suitable for a shooting mode and of obtaining a favorable image without regard to shooting conditions.

As the shooting mode information storage portion, a hard disk apparatus, a magneto-optical disk apparatus, a nonvolatile memory such as flash memory, a read-only memory medium such as a CR-ROM, a volatile memory such as RAM Random Access Memory), or a combination of these may be used.

The control circuit 7 in FIG. 1 may be implemented by dedicated hardware. Alternatively, the control circuit 7 may be made of memory and a CPU (central processing unit), the function of which is implemented by loading the program for implementing the function of the control circuit 7 into the memory and executing it.

While embodiments of the present invention have been described above in detail with reference to the drawings, the specific configuration thereof is not limited to these embodiments. Designs and the like which do not depart from the spirit or scope of this invention are also included.

What is claimed is:

1. A solid-state image pickup apparatus comprising:
a pixel portion in which at least one pixel with a photo-electric conversion element is arranged;
an analog/digital converter comprising:
a delay circuit in which delay elements are connected in multiple stages, the delay elements having a delay amount in accordance with a difference between an output voltage that is output from the pixel portion for every pixel and a predetermined reference voltage; and
a decoder portion that, after detecting a number of circulations, in the delay circuit of a pulse propagating in the delay circuit and a number of stages, of the delay elements connected in multiple stages, through which the pulse has propagated, outputs a digital signal based on the detected number of circulations and stages for each of the pixels; and
a control circuit which controls the analog/digital converter so as to modify a number of bits of the digital signal that is output from the analog/digital converter, in accordance with a preset shooting mode, wherein
the control circuit modifies a period where the pulse propagates in the delay circuit.

2. The solid-state image pickup apparatus according to claim 1, wherein
the decoder portion comprises:
a counter circuit which counts a number of circulations that the pulse has circulated in the delay circuit; and
a latch & encoder circuit which detects a number of stages through which the pulse has propagated in the delay element connected in multiple stages.

3. The solid-state image pickup apparatus according to claim 1, further comprising
a number-of-bits control portion which adjusts a number of bits of the digital signal that is output from the analog/digital converter, wherein
the control circuit modifies the number of bits adjusted by the number-of-bits control portion in accordance with a preset shooting mode.

4. A solid-state image pickup apparatus comprising:
a pixel portion in which at least one pixel with a photo-electric conversion element is arranged;
an analog/digital converter comprising:
a delay circuit in which delay elements are connected in multiple stages, the delay elements having a delay amount in accordance with a difference between an output voltage that is output from the pixel portion for every pixel and a predetermined reference voltage; and
a decoder portion that, after detecting a number of circulations, in the delay circuit, of a pulse propagating in the delay circuit and a number of stages, of the delay elements connected in multiple stages, through which the pulse has propagated, outputs a digital signal based on the detected number of circulations and stages for each of the pixels; and
a control circuit which controls the analog/digital converter so as to modify a number of bits of the digital signal that is output from the analog/digital converter, in accordance with on a preset shooting mode, wherein
the control circuit modifies a counting period of the counter circuit which counts a number of circulations that the pulse has circulated in the delay circuit.

5. The solid-state image pickup apparatus according to claim 4, wherein
the decoder portion comprises:
a counter circuit which counts a number of circulations that the pulse has circulated in the delay circuit; and
a latch & encoder circuit which detects a number of stages through which the pulse has propagated in the delay element connected in multiple stages.

6. The solid-state image pickup apparatus according to claim 4, further comprising
a number-of-bits control portion which adjusts a number of bits of the digital signal that is output from the analog/digital converter, wherein
the control circuit modifies the number of bits adjusted by the number-of-bits control portion in accordance with a preset shooting mode.
